(19) United States
(12) Patent Application Publication
(10) Pub. No.: US 2026/0054985 A1
(43) Pub. Date: Feb. 26, 2026

(54) METHOD OF PREPARING BLACK PHOSPHORUS CRYSTALS

(71) Applicant: HUBEI XINGFA CHEMICALS GROUP CO, LTD, Yichang, Hubei (CN)

(72) Inventors: Jiannan WANG, Yichang, Hubei (CN); Chang LIU, Yichang, Hubei (CN); Ting LI, Yichang, Hubei (CN); Lisheng CHEN, Yichang, Hubei (CN); Zhu HUANG, Yichang, Hubei (CN); Jia LI, Yichang, Hubei (CN)

(73) Assignee: HUBEI XINGFA CHEMICALS GROUP CO, LTD, Yichang, Hubei (CN)

(21) Appl. No.: 19/104,225

(22) PCT Filed: Jul. 10, 2023
(86) PCT No.: PCT/CN2023/106563

§ 371 Date: Feb. 16, 2025

(30) Foreign Application Priority Data
Sep. 1, 2022 (CN) 202211067576.0

(51) Int. Cl. C01B 25/02

(52) U.S. Cl. CPC C01B 25/02; C01P 2002/72; C01P 2002/88

(57) ABSTRACT

Provided is a method of preparing black phosphorus crystal. First, one area of a double-opening reactor is used as the feedstock area, the other area is used as the nucleation area, and the middle area is used as a transition section, and the feedstock area is sealed, the phosphorus feedstock and the transport agent are weighed and placed inside the feedstock area under an inert atmosphere, then the nucleation area is sealed, the first step of heating reaction is performed in the reactor through an optimized temperature-control program, when the reaction is complete, monoclinic phosphorus crystals are prepared in the feedstock area. Then the nucleation area of the reactor is started, the weighed catalyst is placed inside the feedstock area under an inert atmosphere, and the nucleation area is sealed, and then the second step of a heating reaction is performed in the reactor through an optimized temperature-control program.

### FIELD

The present invention belongs to the technical field of two-dimensional materials, and specifically relates to a method of preparing black phosphorus crystals with low energy consumption and high efficiency.

### BACKGROUND

As a typical representative of two-dimensional materials, the discovery of graphene was honored with the 2010 Nobel Prize in Physics and set off a research boom in two-dimensional materials. However, since the graphene itself has no bandgap, its applications have been limited in some fields such as the semiconductor industry and optoelectronic devices. In recent years, black phosphorus, which has a two-dimensional layer structure like graphene, has been regarded as a new super material and has attracted much attention worldwide upon its appearance.

Black phosphorus is a non-metallic layered semiconductor and is the most stable of the elemental phosphorus isomers. Black phosphorus is stacked by pleated phosphorus layers through weak van der Waals forces, and it can be exfoliated to form monolayers and multilayers of two-dimensional (2D) nanosheets, where each phosphorus atom within a phosphorus monolayer is covalently bonded to three neighboring phosphorus atoms to form a pleated phosphorus layer structure, and the phosphorus layers are tightly bonded together between the layers by van der Waals forces. Compared with other 2D nanomaterials, nanoscale black phosphorus has a pleated structure and bilayer structure along the zigzag direction, and its pleated structure gives black phosphorus a higher specific surface area. Moreover, black phosphorus has a tunable and thickness-depportionent bandgap. In contrast to the zero bandgap of graphene and the large bandgap (1˜2.0 eV) of disulfide (TMD), the bandgap of black phosphorus is related to thickness, which can be tuned from 0.3 eV to 2.0 eV by controlling the thickness of black phosphorus, and the tunable bandgap indicates the broad absorption of black phosphorus in the ultraviolet light and the entire visible light region. Additionally, black phosphorus nanosheets have good carrier mobility (10³ cm²·V⁻¹s⁻¹), and thus black phosphorus is considered to have potential applications in electronic and optoelectronic devices. The excellent electronic and optical properties of black phosphorus, including tunable bandgap, high carrier mobility, and broad light absorption, provide the material large potential for many applications, including solar cells, photocatalysis, crystal effect transistors, and optical sensors. In addition, its low cytotoxicity and optical properties enable the use in cancer therapy and biosensors.

The preparation of black phosphorus crystals has also undergone a long research process. Since Bridgeman discovered in 1914 that white phosphorus can be transformed into black phosphorus under high temperature and high pressure, researchers have developed various methods for the preparation of black phosphorus crystals in the past hundred years. For example, mercury-catalyzed method, high-energy ball milling method, etc., but all of them are limited by harsh preparation conditions, complex reaction devices and the like. Until 2007, Nilges reported a method to transform red phosphorus into black phosphorus by using gold and tin as catalysts under low-pressure conditions, which also laid a solid foundation for the preparation of black phosphorus crystals by chemical vapor transmission (CVT), which is the most widely used method today.

However, the current preparation method based on chemical vapor transmission method usually needs high temperature (above 550° C.) and high pressure, as well as long reaction time (above 24 h), high energy consumption is high for the reaction as well, and the raw feedstock conversion efficiency and black phosphorus yield in the scaled-up preparation process are generally low, which makes it difficult to realize the industrialized scale preparation. For this reason, many improvements have been carried out, mainly including two major aspects of phosphorus feedstock treatment and catalyst optimization The former, such as patent CN111646442B disclosed a red phosphorus preparation method and crystalline red phosphorus, in which amorphous red phosphorus and iodine in proportion were placed in a reaction vessel to react under vacuum conditions at 480° C. for 20 h to obtain crystalline red phosphorus. Patent CN106744754A disclosed a red phosphorus pretreatment method for the preparation of black phosphorus, the red phosphorus was heated to 150˜300° C. for 1˜4 h under a protective atmosphere, and then cooled down and grounded or ball milled to obtain the pretreated red phosphorus powder The latter, for example, patent CN112939065 A disclosed a preparation method of black phosphorus catalyst, which mixed tin triphosphide and tin iodide compounds and then carried out temperature programming treatment under inert atmosphere or vacuum conditions to obtain an efficient catalyst Sn24P19.318 used in mineralization method for the preparation of black phosphorus. Patent CN113559886A disclosed a preparation method of catalyst for highly efficient synthesizing black phosphorus, in which the phosphorus iodine tin powder and the carbon material additive were mixed and grounded evenly and then extruded and molded, after that carried out high-temperature treatment so as to obtain the solidified catalyst containing the additive, and finally it can be used for the preparation of black phosphorus. The addition of the carbon material additives can greatly improve the mechanical properties and thermal conductivity of the catalyst, thus increasing the conversion rate and cycle times of the catalyst for the preparation of black phosphorus.

In summary, current optimization methods, both for phosphorus feedstock treatment and catalyst optimization, are often constrained by complex procedures and high production costs. Methods for feedstock optimization directly during the reaction process have rarely been reported. In this regard, the development of a low-energy, efficient and controllable method for the preparation of black phosphorus crystals is of great value in broadening the industrial-scale applications of black phosphorus materials in many fields, such as optoelectronic devices, energy catalysis and biomedicine.

### SUMMARY

The present invention adopts a two-step method to successfully realize the preparation of black phosphorus crystals with low energy consumption and high efficiency. First, under an inert atmosphere, the phosphorus raw material and transport agent are weighed and placed inside a reactor in order to perform the first step of heating reaction to prepare monoclinic phosphorus crystals, and then the weighed catalyst is placed inside the reactor for the second step of heating reaction, and finally high-quality black phosphorus crystals are prepared Compared with the traditional one-step heating reaction using phosphorus raw material, catalyst and transport agent, the present method can effectively reduce the temperature and pressure required for the reaction, shorten the reaction time, reduce the energy consumption required for the reaction, improve the raw material conversion efficiency and black phosphorus yield, and is more conducive to the realization of industrial-scale preparation of black phosphorus crystals.

In order to achieve the above objectives, the technical solutions adopted in the present invention are:

A low-energy and high-efficiency method for preparing black phosphorus crystals with low energy consumption and high efficiency, comprising the steps of:
(1) One area of the double-opening reactor is used as the feedstock area, the other area is used as the nucleation area, and the middle section is used as the transition area, and the feedstock area of the reactor is sealed,
(2) In an inert atmosphere, the phosphorus feedstock and transport agent are weighed and placed inside the feedstock area of step (1) and the nucleation area is sealed, and then the first step of heating reaction on the feedstock area, transition area and nucleation area of the sealed reactor is performed through a temperature-control program;
(3) When the reaction is complete, monoclinic phosphorus crystals are prepared at the feedstock area,
(4) The nucleation area of the reactor is started, and under inert atmosphere, the catalyst continuously is added into the feedstock area of step (3) and the nucleation area is sealed, and then the second step of heating reaction on the feedstock area, transition area and nucleation area of the sealed reactor is performed through a temperature-control program;
(5) When the reaction is complete, black phosphorus crystals are finally prepared in the nucleation area.

The following technical solutions, as preferable technical solutions of the present invention, are not limitations of the technical solutions provided by the present invention, and the technical objects and beneficial effects of the present invention can be better achieved and realized by the following technical solutions.

In the above embodiment, the reactor is a double-opening reactor that can be opened and sealed independently at both areas and completely sealed at the middle area.

In the above embodiment, the feedstock area is either area of the double-opening reactor, the nucleation area is the opposing area of the feedstock area, and the transition area is the remaining area except the feedstock area and the nucleation area.

In the above embodiment, the material of the reactor is any one of quartz, carbon steel, carbon manganese steel, stainless steel, Hastelloy, titanium alloy, nickel alloy, zirconium alloy or a combination of at least two.

Preferably, the material of the reactor is any one of stainless steel, Hastelloy, titanium alloy, nickel alloy, zirconium alloy or a combination of at least two.

In the above embodiment, the inert atmosphere is nitrogen or argon or a combination of both.

In the above embodiment, the phosphorus feedstock is yellow phosphorus or amorphous red phosphorus or a combination of both.

In the above embodiment, the transport agent is any one of I₂, SnI₄, SnI₂, PbI₂, NH₄I, BiI₃, PI₃, SnCl₂, SnBr₂ or a combination of at least two of them, and the purity of the transport agent is 95% or more.

Preferably, the transport agent is any one of I₂, SnI₄, SnI₂, PbI₂, BiI₃, PI₃ or a combination of at least two of them. The purity of the transport agent is 98% or more.

In the above embodiment, the mass feed ratio of the phosphorus feedstock and transport agent is 100:0.1˜2.

Preferably, the mass feed ratio of the phosphorus feedstock and transport agent is 100:0.5˜1.

In the above embodiment, the temperature-control program is specified as follows: at room temperature, the temperature of the feedstock area is increased to 280˜320° C. by 0.5˜1 h, held for 6-12 h, and then reduced to room temperature by 1˜2h; the temperature of the transition area is increased to 300˜330° C. by 0.5-1 h, held for 6-12 h, and then reduced to room temperature by 1˜2 h; and the temperature of the nucleation area was increased to 320-340° C. by 0.5-1 h, held for 6-12 h, and then reduced to room temperature by 1˜2 h.

Preferably, the temperature-control program is specifically as follows: at room temperature, the temperature of the feedstock area is increased to 290˜310° C. by 0.5˜1 h, held for 8˜10 h, and then reduced to room temperature by 1˜2 h; the temperature of the transition area is increased to 310˜320° C. by 0.5 Th, held for 8-10 h, and then reduced to room temperature by 1-2 h, the temperature of the nucleation area is increased to 325-335° C. by 0.5˜1 h, held for 8-10 h, and then reduced to room temperature by 1˜2 h.

In the above embodiment, the temperature-control program is as follows: the temperature-control program of the feedstock area, the transition area and the nucleation area is synchronized, and the temperature of the nucleation area is always 20˜40° C. higher than the temperature of the feedstock area; the temperature of the transition area is between them and is always 10-20° C. higher than the temperature of the feedstock area, 10˜20° C. lower than the temperature of the nucleation area until it is reduced to room temperature.

Preferably, the temperature-control program is as follows: temperature-control program of the feedstock area, the transition area and the nucleation area is synchronized, and the temperature of the nucleation area is always 25˜35° C. higher than the temperature of the feedstock area; the temperature of the transition area is between them and is always 15˜20° C. higher than the temperature of the feedstock area, and is 10˜15° C. lower than the temperature of the nucleation area until it is reduced to room temperature.

In the invention, the feedstock area is a high temperature section and the nucleation area is a low temperature section.

In the above embodiment, the catalyst is any one or a combination of at least two of Sn, Pb, In, Bi, Cd, or an alloy containing any one or a combination of at least two elements of Sn, Pb, In, Bi, Cd, and the purity of the catalyst is 98% or more.

Preferably, the catalyst is any one or a combination of at least two of Sn, Pb, In, Bi, or an alloy containing any one or a combination of at least two elements of Sn, Pb, In, Bi. The catalyst has a purity of 99% or more.

In the above embodiment, the mass feed ratio of the phosphorus feedstock and catalyst is 100:0.2˜4.

Preferably, the mass feed ratio of the phosphorus feedstock and catalyst is 100:1˜2.

In the above embodiment, the temperature-control program is as follows: at room temperature, the temperature of the feedstock area is increased to 450-480° C. by 0.5-1 h, held for 6-12 h, and then reduced to room temperature by 2-4 h; the temperature of the transition area is increased to 445-470° C. by 0.5˜1 h, held for 6˜12 h, and then reduced to room temperature by 2-4 h; the temperature of the nucleation area is increased to 440-460° C. by 0.5˜1 h, held for 6-12 h, and then reduced to room temperature by 2˜4 h.

Preferably, the temperature-control program is as follows: at room temperature, the temperature of the feedstock area is increased to 460˜470° C. by 0.5-1 h, held for 8-10 h, and then reduced to room temperature by 2-4 h, the temperature of the transition area is increased to 450˜465° C. by 0.5-1 h, held for 6˜12 h, and then reduced to room temperature by 2˜4 h; the temperature of the nucleation area is increased to 445-455° C. by 0.5-1 h, held for 8˜10 h, and then reduced to room temperature by 2-4 h.

In the above embodiment, the temperature-control program is as follows: the temperature-control program of the feedstock area, the transition area and the nucleation area is synchronized, and the temperature of the feedstock area is always 10˜40° C. higher than the temperature of the nucleation area; the temperature of the transition area is between them, and is always 5-20° C. lower than the temperature of the feedstock area, and is 5˜20° C. higher than the temperature of the nucleation area until it is reduced to room temperature.

Preferably, the temperature-control program is as follows: the temperature-control program of the feedstock area, the transition area and the nucleation area is synchronized, and the temperature of the feedstock area is always 20˜30° C. higher than the temperature of the nucleation area. The temperature of the transition area is between them, and is always 5-10° C. lower than the temperature of the feedstock area and 15-20° C. higher than the temperature of the nucleation area, until it is reduced to room temperature.

The present invention adopts a two-step method to successfully realize the preparation of black phosphorus crystals with low energy consumption and high efficiency. First, under an inert atmosphere, the phosphorus raw material and transport agent are weighed to carry out the first step of heating reaction to prepare monoclinic phosphorus crystals, and then continuously adding the catalyst into the closed reactor to carry out the second step of heating, reaction, finally high quality black phosphorus crystals are prepared.

Compared with the prior art, the beneficial effect of the present invention is as follows: in the present invention, the monoclinic phosphorus crystals are obtained by performing the first step of the heating reaction to the weighed phosphorus raw material and transport agent under an inert atmosphere. Compared with the conventional amorphous red phosphorus, the monoclinic phosphorus has a lower volatilization temperature, and the thermogravimetric test results show that the volatilization temperature of the amorphous red phosphorus is about 500° C., and the maximum weight loss rate temperature is 510° C., while the volatilization temperature of the monoclinic phosphorus is only 400° C., and the maximum weight loss rate temperature is only 430° C. and 500° C. The volatilization temperature of amorphous red phosphorus is 500° C., and monoclinic phosphorus is 400° C., which indicates that the volatilization of phosphorus raw materials can be achieved at lower temperatures. The use of monoclinic phosphorus feedstock can effectively reduce the temperature required for the second step of the black phosphorus preparation reaction.

The maximum weight loss rate temperature of amorphous red phosphorus is 510° C., while the maximum weight loss rate temperatures of monoclinic phosphorus are only 430° C. and 500° C., which indicates that the volatilization of monoclinic phosphorus is a slow process under heating, while the volatilization of amorphous red phosphorus is a fast process, which is more obvious in the high temperature section of the cake cutter, which is apparent from the DTG curves in the thermogravimetric data.

Therefore, under the same conditions, the volatilization rate of the former is much smaller than that of the latter, and the use of monoclinic phosphorus feedstock can effectively reduce the temperature required for the black phosphorus preparation reaction in the second step. And due to the existence of the crystalline structure, the stability of monoclinic phosphorus is obviously better than that of amorphous red phosphorus, which makes the volatilization rate of the former under the same conditions much smaller than that of the latter, so the use of monoclinic phosphorus feedstock can effectively reduce the pressure required for the black phosphorus preparation reaction in the second step.

In the present invention, the monoclinic phosphorus crystals are prepared by performing the first step of heating reaction to the weighed phosphorus raw material and transport agent under an inert atmosphere. Compared with the traditional yellow phosphorus, whose volatilization temperature is below 100° C., a large amount of volatilization will occur at the early stage of the reaction, resulting in a rapid increase in pressure in the system, which is not conducive to the control of the reaction process. The stable crystal structure of monoclinic phosphorus perfectly avoids this defect. Moreover, the monoclinic phosphorus is more stable at room temperature, which is more conducive to the practical operation. Therefore, the use of monoclinic phosphorus as raw material can efficiently control the temperature and pressure required for the black phosphorus preparation reaction in the second step.

In the present invention, the weighed catalyst is continuously placed inside the closed reactor for the second step of heating reaction, and finally high-quality black phosphorus crystals are obtained. As the transport agent in the first step bas a certain activating effect on the phosphorus raw material, the low-boiling by-products generated in the reaction will be attached to the surface of the monoclinic phosphorus, which is more conducive to combining with the catalyst to promote the generation of black phosphorus nucleation sites in the early stage of the reaction and improve the crystal growth rate, therefore, the use of monoclinic phosphorus raw material can effectively shorten the reaction time, reduce the energy consumption required for the reaction, improve the raw material conversion efficiency and black phosphorus yield, which is more conducive to the realization of the preparation of black phosphorus crystals in industrial scale.

The benefit of the present invention is that: the raw materials is easy to be obtained, the reaction conditions are mild and easy to be regulated, the operation process is simple and reproducible, which can be synthesized in large quantities.

### BRIEF DESCRIPTION OF THE DRAWINGS

FIG. 1 shows a physical diagram of the used amorphous red phosphorus and the prepared monoclinic phosphorus in Example 1.

FIG. 2 shows the X-ray diffraction spectra of the used amorphous red phosphorus and the prepared monoclinic phosphorus in Example 1.

FIG. 3 shows the TG and DTG spectra of the used amorphous red phosphorus and the prepared monoclinic phosphorus in Example 1.

FIG. 4 shows a physical diagram of the black phosphorus crystals prepared in Example 1.

FIG. 5 shows the X-ray diffraction spectrum of the black phosphorus crystals prepared in Example 1.

FIG. 6 shows a physical diagram of the black phosphorus crystals prepared in Example 4.

FIG. 7 shows a physical diagram of the black phosphorus crystals prepared in Example 5.

FIG. 8 shows a physical diagram of the black phosphorus crystals prepared in Example 6.

### DETAILED DESCRIPTION

For a better understanding of the present invention, the present invention is further illustrated below in connection with specific embodiments and the accompanying drawings, but the present invention is not limited to the following embodiments.

The double-opening reactor of the present invention is a customized device, the customized enterprise is Yantai Artisan Machinery Technology Co and the device model is ATS-BP02.

### Example 1

A method of preparing black phosphorus crystals with low energy consumption and high efficiency, including the following preparation steps:
(1) One area of a stainless steel double-opening reactor was used as the feedstock area and the other area as the nucleation area, the middle section as the transition area, and the feedstock area of the reactor was sealed.
(2) Under the nitrogen inert atmosphere, 160 g of amorphous red phosphorus and 1.28 g of transport agent I₂ were weighed and placed inside the feedstock area, and the nucleation area was sealed, and then the first step of heating reaction was carried out in the feedstock area and the nucleation area of the reactor through a temperature-controlled program, which was as follows: under the room temperature, the temperature of the feedstock area was increased to 300° C. by 0.6 h, held for 9 h, and then reduced to room temperature by 1.5 h, the temperature of the transition area was increased to 315° C. by 0.6 h, held for 9 h, and then reduced to room temperature by 1.5 h; the temperature of the nucleation area was increased to 330° C. by 0.6 h, held for 9 h, and then reduced to room temperature by 1.5 h. The temperature-control programs of the feedstock area, transition area and nucleation area were synchronized, and the temperature of the nucleation area was always 30° C. higher than that of the feedstock area; the temperature of the transition area was between them, and it was always 17.5° C. higher than that of the feedstock area, and 12.5° C. lower than that of the nucleation area until it was reduced to room temperature.
(3) When the reaction was complete, the monoclinic phosphorus crystals were prepared at the feedstock area.
(4) Starting the nucleation area of the reactor, under the nitrogen inert atmosphere, in the feedstock area including the monoclinic crystals of step (3), 2.4 g of catalyst Sn were placed inside the feedstock area, and the nucleation area was sealed, and then the second step of the heating reaction was carried out in the feedstock area and the nucleation area of the reactor through the temperature-controlled program, specifically as follows: under room temperature, the temperature of the feedstock area was increased to 465° C. by 0.8 h, held for 9 h, then reduced to room temperature by 3 h, the transition area temperature was increased to 460° C. by 0.8 h, held for 9 h, and then reduced to room temperature by 3 h; the nucleation area temperature was increased to 450° C. by 0.8 h, held for 9 h, and then reduced to room temperature by 3 h. The temperature-control programs of the feedstock area, transition area and nucleation area were synchronized, and the temperature of the feedstock area was always 15° C. higher than that of the nucleation area; the temperature of the transition area was between them, and it was always 7.5° C. lower than that of the feedstock area, and 17.5° C. higher than that of the nucleation area until it was reduced to room temperature.
(5) When the reaction is complete, high quality black phosphorus crystals were finally prepared of the nucleation area.

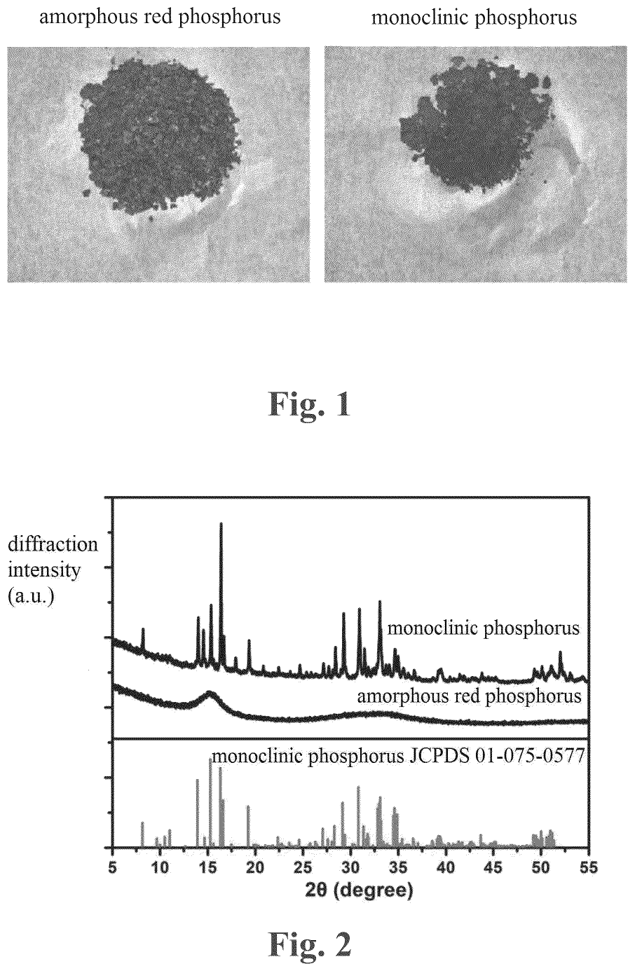

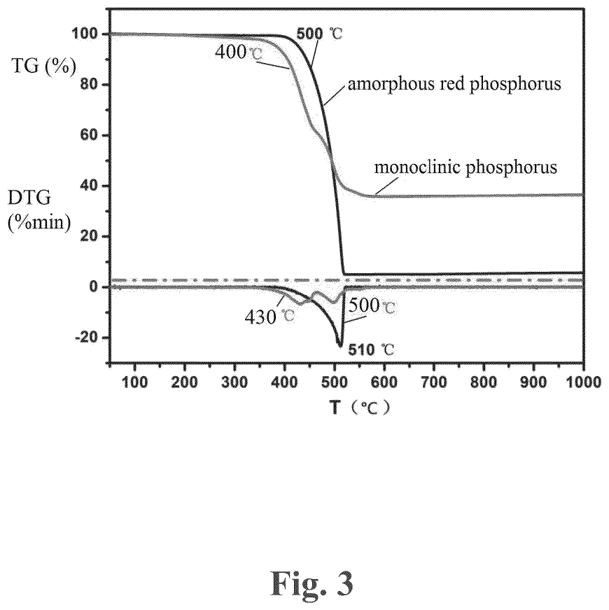

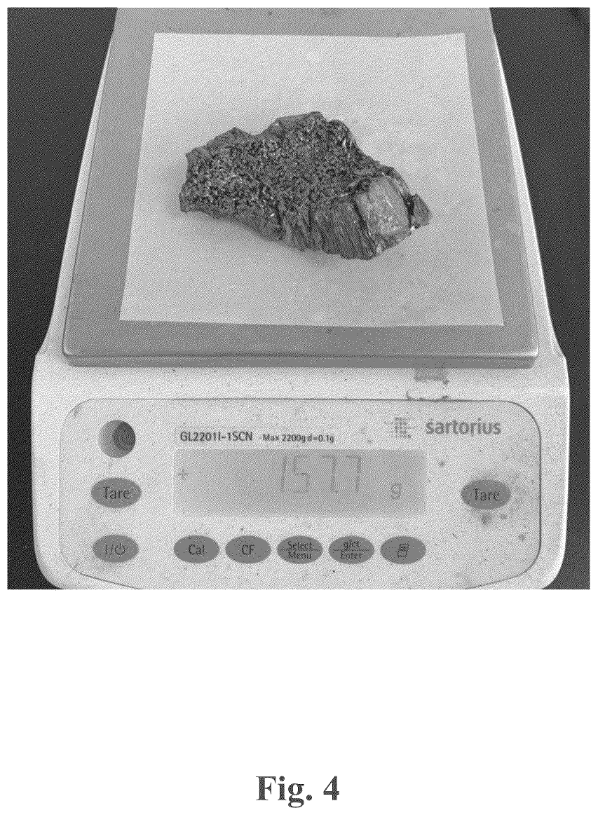

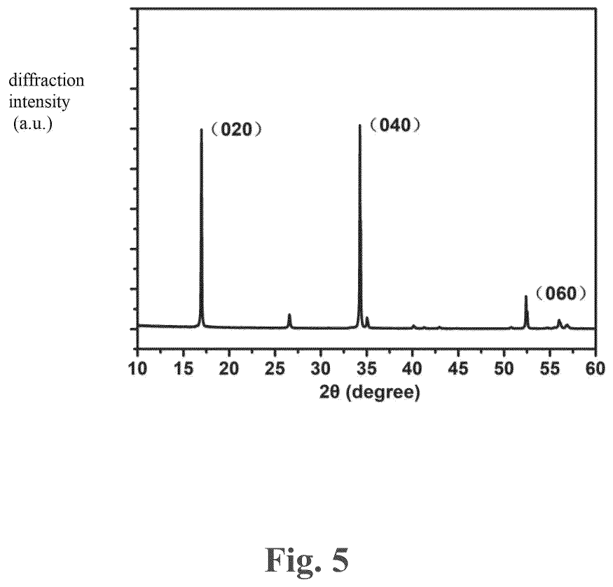

FIG. 1 showed a physical diagram of the used amorphous red phosphorus and the prepared monoclinic phosphorus in Example 1, from which it can be seen that the monoclinic phosphorus is lighter in color compared to the amorphous red phosphorus, and is a loose powdery crystal, which is mainly related to the activation of the phosphorus feedstock by the transport agent FIG. 2 showed the X-ray diffraction spectra of the used amorphous red phosphorus and the prepared monoclinic phosphorus in Example 1, from which it can be seen that the amorphous red phosphorus has no obvious diffraction peaks, while the diffraction peaks of the monoclinic phosphorus have a higher intensity and are well-matched with the standard PDF card, indicating that the prepared monoclinic phosphorus is well-crystallized, the black phosphorus has a high purity. FIG. 3 showed the TG and DTG spectra of the used amorphous red phosphorus and the prepared monoclinic phosphorus in Example 1, from which it can be seen that the volatilization temperature of the amorphous red phosphorus is about 500° C., and the maximum weight loss rate temperature is 510° C., whereas the volatilization temperature of the monoclinic phosphorus is only 400° C., and the maximum weight loss rate temperatures are only 430° C. and 500° C., and under the same conditions, the heat loss of monoclinic phosphorus is about 30% lower than that of amorphous red phosphorus, which indicates that monoclinic phosphorus has a lower volatilization temperature and volatilization rate, and the use of monoclinic phosphorus feedstock can effectively reduce the temperature and pressure required for the second step of the black phosphorus preparation reaction. FIG. 4 showed a physical diagram of the black phosphorus crystals prepared in Example 1, from which it can be seen that the black phosphorus crystals appear as massive crystals having a metallic luster, weighing 157.7 g, with a total yield of 98.16%. FIG. 5 showed the X-ray diffraction spectrum of the black phosphorus crystals prepared in Example 1, from which it can be seen that the sample exhibits typical characteristic peaks of black phosphorus and no other miscellaneous peaks appeared, which indicates that the prepared black phosphorus crystals are well crystallized and has a high purity. The three strong characteristic peaks match the crystal faces of (020), (040) and (060) of the black phosphorus crystals respectively.

### Example 2

The method and steps are the same as in Example 1, except that in step (2), the temperature control program of the feedstock area, transition area and nucleation area of the reactor was adjusted as follows: under the room temperature, the temperature of the feedstock area is increased to 280° C. by 0.6 h, held for 9 h, and then reduced to room temperature by 1.5 h; the temperature of the transition area is increased to 300° C. by 0.6 h, held for 9 h, and then reduced to room temperature by 1.5h; and the temperature of the nucleation area is increased to 330° C. by 0.6 h, held for 9 h, and then reduced to room temperature by 1.5 h. The temperature-control programs of the feedstock area, transition area and nucleation area were synchronized, and the temperature of the nucleation area was always 50° C. higher than that of the feedstock area, while the temperature of the transition area was between them, and it was always 20° C. higher than that of the feedstock area, and 30° C. lower than that of the nucleation area until it was reduced to room temperature. Due to the large temperature difference, monoclinic phosphorus could not be prepared, and the product was still granular amorphous red phosphorus.

In another embodiment of the present invention, under the room temperature, the temperature of the feedstock area was increased to 290° C. by 0.6 h, held for 9 h, and then reduced to room temperature by 1.5 h; the temperature of the transition area was increased to 310° C. by 0.6 h, held for 9 h, and then reduced to room temperature by 1.5 h; and the temperature of the nucleation area was increased to 330° C. by 0.6 h, held for 9 h, and then reduced to room temperature by 1.5 h. The temperature-control programs of the feedstock area, transition area and nucleation area were synchronized, and nucleation area temperature is always 40° C. higher than that of the feedstock area, the transition area of the temperature between them, and always 20° C. higher than the temperature of the feedstock area, 20° C. lower than the temperature of the nucleation area, until it was reduced to room temperature, and other conditions were the same as in Example 1. When the temperature difference was controlled in a suitable range, the monoclinic phosphorus can be obtained with the morphology and characteristics similar to that of Example 1, the total yield of monoclinic phosphorus can be up to 99.9%.

In another embodiment of the present invention, under the room temperature, the temperature of the feedstock area was increased to 310° C. by 0.6 h, held for 9 h, and then reduced to room temperature by 1.5 h; the temperature of the transition area was increased to 320° C. by 0.6 h, held for 9 h, and then reduced to room temperature by 1.5 h; and the temperature of the nucleation area was increased to 330° C. by 0.6 h, held for 9 h, and then reduced to room temperature by 1.5 h. The temperature-control programs of the feedstock area, transition area and nucleation area were synchronized, and the temperature of the nucleation area was always 20° C. higher than that of the feedstock area, the temperature of the transition area was between them, and always 10° C. higher than that of the feedstock area, 10° C. lower than that of the nucleation area temperature, until it was reduced to room temperature, and other conditions were the same as in Example 1. When the temperature difference was controlled in a suitable range, the monoclinic phosphorus can be obtained with the morphology and characteristics similar to that of Example 1, the total yield of monoclinic phosphorus can be up to 99.9%.

In another embodiment of the present invention, under the room temperature, the temperature of the feedstock area was increased to 320° C. by 0.6 h, held for 9 h, and then reduced to room temperature by 1.5 h; the temperature of the transition area was increased to 325° C. by 0.6 h, held for 9 h, and then reduced to room temperature by 1.5 h; the temperature of the nucleation area was increased to 330° C. by 0.6 h, held for 9 h, and then reduced to room temperature by 1.5 h. The temperature-control programs of the feedstock area, transition area and nucleation area were synchronized, and the temperature of the nucleation area was always 10° C. higher than that of the feedstock area, the transition area temperature between them, and was always 5° C. higher than that of the feedstock area, 5° C. lower than that of the nucleation area, until it was reduced to room temperature, and other conditions were the same as in Example 1. Since the temperature difference was too small, the monoclinic phosphorus cannot be prepared, the product was still a granular amorphous red phosphorus.

In another embodiment of the present invention, under the room temperature, the temperature of the feedstock area was increased to 320° C. by 0.6 h, held for 9 h, and then reduced to room temperature by 1.5 h; the temperature of the transition area was increased to 320° C. by 0.6 h, held for 9 h, and then reduced to room temperature by 1.5 h; the temperature of the nucleation area was increased to 320° C. by 0.6 h, held for 9 h, and then reduced to room temperature by 1.5 h. The temperature-control programs of the feedstock area, transition area and nucleation area were synchronized, and there was no temperature difference between the feedstock area, transition area and nucleation area until it was reduced to room temperature, and other conditions were the same as in Example 1. Due to the lack of a temperature difference, the monoclinic phosphorus cannot be prepared, and the product was still granular amorphous red phosphorus.

### Example 3

The method and steps are the same as in Example 1, except that in step (4), the temperature control program of the feedstock area, the transition area and the nucleation area of the reactor was adjusted as follows: under the room temperature, the temperature of the feedstock area was increased to 450° C. by 0.8 h, held for 9 h, and then reduced to room temperature by 3 h; the temperature of the transition area was increased to 450° C. by 0.8 h, held for 9 h, and then reduced to room temperature by 3 h; and the temperature of the nucleation area was increased to 450° C. by 0.8 h, held for 9 h, and then reduced to room temperature by 3h. The temperature-control programs of the feedstock area, transition area and nucleation area were synchronized, and there was no temperature difference between the feedstock area, transition area and nucleation area until the temperature was reduced to room temperature. Due to the small temperature difference, the black phosphorus cannot be prepared, and the product was still powdery monoclinic phosphorus crystals, which cannot be transformed to black phosphorus crystals.

In another embodiment of the present invention, under the room temperature, the temperature of the feedstock area was increased to 455° C. by 0.8 h, held for 9 h, and then reduced to room temperature by 3 h. The temperature of the transition area was increased to 452.5° C. by 0.8 h, held for 9 h, and then reduced to room temperature by 3 h. The temperature of the nucleation area was increased to 450° C. by 0.8 h, held for 9 h, and then reduced to room temperature by 3 h. The temperature-control programs for the feedstock area, transition area and nucleation area were synchronized, and the temperature of the feedstock area was always 5° C. higher than that of the nucleation area. The temperature of the transition area was between them, and was always 2.5° C. lower than that of the feedstock area, 2.5° C. higher than that of the nucleation area, until it was reduced to room temperature, and other conditions are the same as in Example 1. Since the temperature difference is too small, the black phosphorus cannot be prepared, and the product was still powdery monoclinic phosphorus crystals, which cannot be transformed to black phosphorus crystals.

In another embodiment of the present invention, under the room temperature, the temperature of the feedstock area was increased to 475° C. by 0.8 h, held for 9 h, and then reduced to room temperature by 3 h; the temperature of the transition area was increased to 462.5° C. by 0.8 h, held for 9 h, and then reduced to room temperature by 3 h; the temperature of the nucleation area was increased to 450° C. by 0.8 h, held for 9 h, and then reduced to room temperature by 3 h. The temperature-control programs of the feedstock area, transition area and nucleation area were synchronized, and the temperature of the feedstock area was always 25° C. higher than that of the nucleation area. The temperature of the transition area was between them, and was always 12.5° C. lower than that of the feedstock area and 12.5° C. higher than that of the nucleation area until it was reduced to room temperature, and other conditions were the same as in Example 1. Due to the appropriate temperature difference, the black phosphorus can be prepared, which was basically the same in morphology as in Example 1, and weighed 157.02 g with the total yield of 98.13%.

In another embodiment of the present invention, under the room temperature, the temperature of the feedstock area was increased to 480° C. by 0.8 h, held for 9 h, and then reduced to room temperature by 3 h, the temperature of the transition area was increased to 460° C. by 0.8 h, held for 9 h, and then reduced to room temperature by 3 h; the temperature of the nucleation area was increased to 440° C. by 0.8 h, held for 9 h, and then reduced to room temperature by 3 h. The temperature control programs for the feedstock area, transition area and nucleation area were synchronized, and the temperature of the feedstock area is always 40° C. higher than that of the nucleation area. The temperature of the transition area was between them, and was always 20° C. lower than that of the feedstock area and 20° C. higher than that of the nucleation area until it was reduced to room temperature, and other conditions were the same as in Example 1. Due to the appropriate temperature difference, the black phosphorus can be prepared, which was basically the same in morphology as in Example 1, the weight of which was 159.1 g, and the total yield was 99.44%.

### Example 4

A method of preparing black phosphorus crystals with low energy consumption and high efficiency, including the following preparation steps:
(1) One area of a stainless steel double-opening reactor was used as the feedstock area and the other area as the nucleation area, the middle section as the transition area, and the feedstock area of the reactor was sealed.
(2) Under the nitrogen inert atmosphere, 270 g of amorphous red phosphorus and 0.27 g of transport agent SnI₄ were weighed and placed inside the feedstock area and the nucleation area was sealed, and then the first step of heating reaction was carried out in the feedstock area and the nucleation area of the reactor through a temperature-controlled program, which was as follows: under the room temperature, the temperature of the feedstock area was increased to 280° C. by 0.5 h, held for 6 h, and then reduced to room temperature by 1 h; the temperature of the transition area was increased to 300° C. by 0.5 h, held for 6 h, and then reduced to room temperature by 1 h; the temperature of the nucleation area was increased to 320° C. by 0.5 h, held for 6 h, and then reduced to room temperature by 1 h. The temperature-control programs of the feedstock area, transition area and nucleation area were synchronized, and the temperature of the nucleation area was always 40° C. higher than that of the feedstock area; the temperature of the transition area was between them, and was always 20° C. higher than that of the feedstock area, 20° C. lower than that of the nucleation area, until it was reduced to room temperature.
(3) When the reaction was complete, the monoclinic phosphorus crystals were prepared at the feedstock area.
(4) Starting the nucleation area of the reactor, and under the nitrogen inert atmosphere, in the feedstock area including the monoclinic crystals of step (3), 0.54 g of catalyst Bi were placed inside the feedstock area and the nucleation area was sealed, and then the second step of the heating reaction was carried out in the feedstock area and the nucleation area of the reactor through the temperature-controlled program, specifically as follows: under the room temperature, the temperature of the feedstock area was increased to 450° C. by 0.5 h, and then held for 6 h, and then reduced to room temperature by 2 h; the temperature of the transition area was increased to 445° C. by 0.5 h, held for 6 h, and then reduced to room temperature by 2 h; the temperature of the nucleation area was increased to 440° C. by 0.5 h, held for 6 h, and then reduced to room temperature by 2 h. The temperature-control programs of the feedstock area, transition area and nucleation area were synchronized, and the temperature of the feedstock area was always 10° C. higher than that of the nucleation area. The temperature of the transition area was between them, and was always 5° C. lower than that of the feedstock area and 5° C. higher than that of the nucleation area until it was reduced to room temperature.
(5) When the reaction was complete, high quality black phosphorus crystals were finally prepared in the nucleation area.

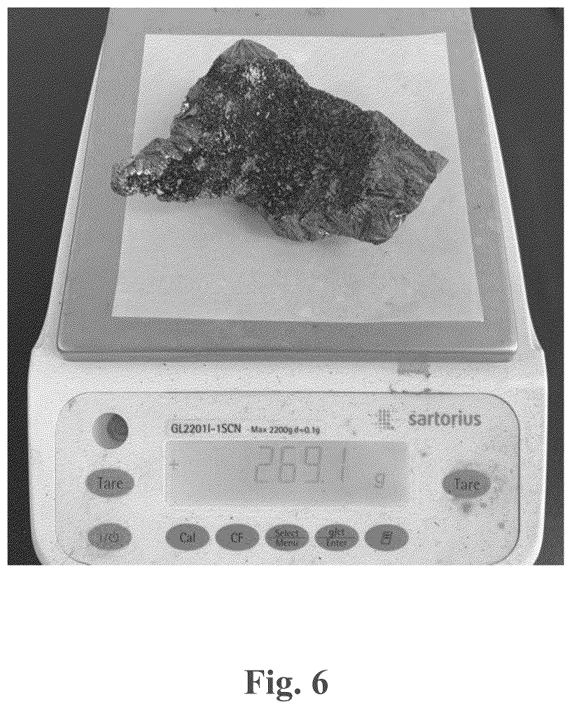

FIG. 6 showed a physical diagram of the black phosphorus crystals prepared in Example 4, from which it can be seen that the black phosphorus crystals appeared as lumpy crystals having a metallic luster, weighing 269.1 g, with a total yield of 99.67%.

### Example 5

A method of preparing black phosphorus crystals with low energy consumption and high efficiency, including the following preparation steps:
(1) One area of the Hastelloy double-opening reactor was used as the feedstock area, the other area as the nucleation area, and the middle section as the transition area, and the feedstock area of the reactor was sealed.
(2) Under a nitrogen inert atmosphere, 380 g of yellow phosphorus and 7.6 g of transport agent Bils were weighed and placed inside the feedstock area, and the nucleation area was sealed, and then the first step of heating reaction was carried out in the feedstock area and the nucleation area of the reactor through the temperature-controlled program, which was as follows: at the room temperature, the temperature of the feedstock area was increased to 320° C. by 1 h, holding 12 h, and then reduced to room temperature by 2 h; the temperature of the transition area was increased to 330° C. by 1 h, held for 12 h, and then reduced to room temperature by 2 h; the temperature of the nucleation area was increased to 330° C. by 1 h, holding 12 h, and then reduced to room temperature by 2 h. The temperature control programs of the feedstock area, transition area and nucleation area were synchronized, and the temperature of the nucleation area was always 20° C. higher than that of the feedstock area; the temperature of the transition area was between them, and was always 10° C. higher than that of the feedstock area, and 10° C. lower than that of the nucleation area, until it was reduced to room temperature.
(3) When the reaction was complete, the monoclinic phosphorus crystals were prepared in the feedstock area.
(4) Starting the nucleation area of the reactor, and under the nitrogen inert atmosphere, in the feedstock area including the monoclinic crystals of step (3), 15.2 g of catalyst In were placed inside the feedstock area, and the nucleation area was sealed, and then the second step of the heating reaction was carried out in the feedstock area and the nucleation area of the reactor through the temperature-controlled program, specifically as follows: under the room temperature, the temperature of the feedstock area was increased to 480° C. by 1 h, held for 12 h, and then reduced to room temperature by 4 h; the temperature of the transition area was increased to 470° C. by 1 h, held for 12 h, and then reduced to room temperature by 4 h; the temperature of the nucleation area was increased to 460° C. by 1 h, held for 12 h, and then reduced to room temperature by 4 h. The temperature-control programs of the feedstock area, transition area and nucleation area were synchronized, and the temperature of the feedstock area was always 20° C. higher than that of the nucleation area, the temperature of the transition area was between them, and it was always 10° C. lower than that of the feedstock area, and 10° C. higher than that of the nucleation area until it was reduced to room temperature.
(5) When the reaction was complete, high quality black phosphorus crystals were finally prepared in the nucleation area.

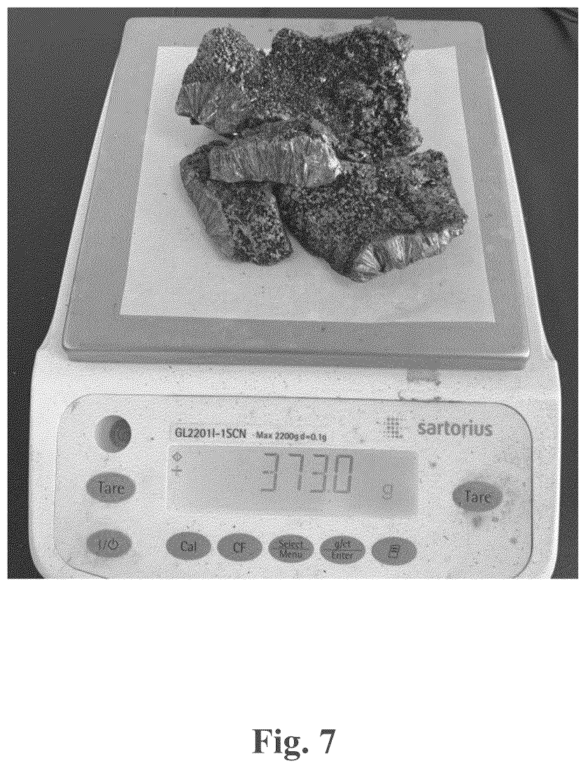

FIG. 7 shows a physical diagram of the black phosphorus crystals prepared in Example 5, from which it can be seen that the black phosphorus crystals appear as massive crystals with a metallic luster, weighing 373.0 g, with a total yield of 98.16%.

### Example 6

A method of preparing black phosphorus crystals with low energy consumption and high efficiency, including the following preparation steps:
(1) One area of a nickel alloy double-opening reactor was used as the feedstock area and the other area as the nucleation area, the middle section as the transition area, and the feedstock area of the reactor was sealed.
(2) Under the argon inert atmosphere, 1020 g of yellow phosphorus and 8.16 g of transport agent PI₃ were weighed and placed inside the feedstock area and the nucleation area was sealed, and then the first step of heating reaction was carried out on the feedstock area and the nucleation area of the reactor through the temperature-controlled program, which was as follows: under the room temperature, the temperature of the feedstock area was increased to 320° C. by 1 h, held for 12 h, and then reduced to the room temperature by 2 h; the temperature of the transition area was increased to The temperature of the transition area was increased to 330° C. for 1 h, held for 12 h, and then reduced to room temperature for 2 h; the temperature of the nucleation area was increased to 340° C. for 1 h, held for 12 h, and then reduced to room temperature for 2 h. The temperature-control programs of the feedstock area, transition area and nucleation area were synchronized, and the temperature of the nucleation area was always 20° C. higher than that of the feedstock area; the temperature of the transition area was between them, and was always 10° C. higher than that of the feedstock area, 10° C. lower than that of the nucleation area, until it was reduced to room temperature.
(3) When the reaction is complete, the monoclinic phosphorus crystals were prepared in the feedstock area.
(4) Starting the nucleation area of the reactor, under argon inert atmosphere, in the feedstock area including the monoclinic crystals of step (3), 15.3 g of catalyst Sn were placed inside the feedstock area, and the nucleation area was sealed, and then the second step of the heating reaction was carried out in the feedstock area and the nucleation area of the reactor through the temperature-controlled program, specifically as follows: under the room temperature, the temperature of the feedstock area was increased to 480° C. through 1 h, held for 12 h, then reduced to room temperature by 4 h, the temperature of the transition area was increased to 470° C. through 1 h, held for 12 h, then reduced to room temperature by 4 h; the temperature of the nucleation area was increased to 460° C. through 1 h, held for 12 h, then reduced to room temperature by 4 h. The temperature-control programs of the feedstock area, transition area and nucleation area were synchronized, and the temperature of the feedstock area was always 20° C. higher than that of the nucleation area; the temperature of the transition area was between them, and it was always 10° C. lower than that of the feedstock area, and 10° C. higher than that of the nucleation area until it was reduced to room temperature.
(5) When the reaction was complete, high quality black phosphorus crystals were finally prepared in the nucleation area.

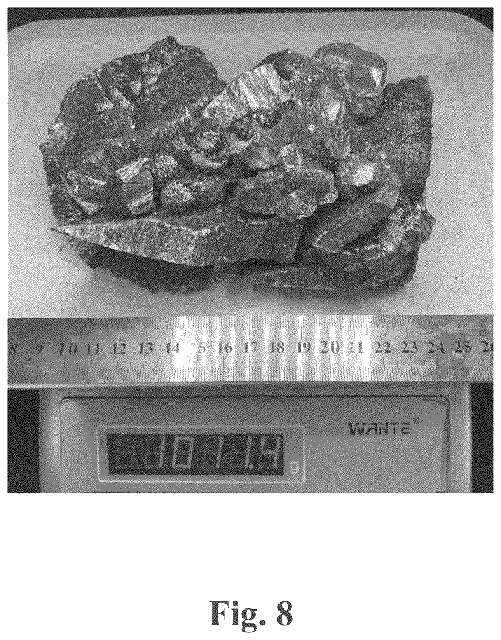

FIG. 8 shows a physical diagram of the black phosphorus crystals prepared in Example 6, from which it can be seen that the black phosphorus crystals appear as massive crystals having a metallic luster, weighing 1011.4 g, with a total yield of 99.16%.

1. A method for preparing black phosphorus crystals, comprising the following steps:
(1) in an inert atmosphere weighting and placing phosphorus feedstock and transport agent inside a feedstock area of a sealed reactor, and performing a first step of heating reaction on the feedstock area and a nucleation area of the sealed reactor through a temperature-control program;
(2) when the first step of heating reaction is complete, preparing monoclinic phosphorus crystals in the feedstock area;
then adding the catalyst continuously into the feedstock area of the sealed reactor, and then performing a second step of heating reaction on the feedstock area and nucleation area of the sealed reactor through a temperature-control program;
(3) when the second step of heating reaction is complete, preparing the black phosphorus crystals in the nucleation area.

2-5. (canceled)

6. The method for preparing black phosphorus crystals according to claim 1, wherein the phosphorus feedstock in step (1) is yellow phosphorus or amorphous red phosphorus or a combination of both.

7. The method for preparing black phosphorus crystals according to claim 1, wherein the transport agent in step (1) is any one of I₂, SnI₄, SnI₂, PbI₂, NH₄I, BiI₃, PI₃, SnCl₂, SnBr₂ or a combination of at least two of them, and the purity of the transport agent is 95% or more.

8. The method of preparing black phosphorus crystals according to claim 1, wherein a mass feed ratio of the phosphorus feedstock and the transport agent in step (1) is 100:0.1˜2.

9. The method of preparing black phosphorus crystals according to claim 1, wherein in the temperature control program in step (1) at room temperature, a temperature of the feedstock area is increased to 280˜320 ° C. by 0.5˜1 h, held for 6˜12 h, and then reduced to the room temperature by 1˜2 h; temperature of the nucleation area was increased to 320˜340° C. by 0.5˜1 h, held for 6˜12 h, and then reduced to room temperature by 1˜2 h.

10. The method of preparing black phosphorus crystals according to claim 9, wherein in the temperature control program in step (1), the temperature control program of the feedstock area and the nucleation area is synchronized, and the temperature of the nucleation area is always 20˜40° C. higher than the temperature of the feedstock area until it is reduced to room temperature.

11. The method for efficiently preparing black phosphorus crystals according to claim 1, wherein the catalyst in step (2) is any one or a combination of at least two of Sn, Pb, In, Bi, Cd, or an alloy containing any one or a combination of at least two elements of Sn, Pb, In, Bi, Cd, and the purity of the catalyst is 98% or more.

12. The method of preparing black phosphorus crystals according to claim 11, wherein the mass feed ratio of the phosphorus feedstock and the catalyst in step (2) is 100:0.2˜4.

13. The method for preparing black phosphorus crystals according to claim 1, wherein the temperature-control program in step (2) is as follows: at room temperature, the temperature of the feedstock area is increased to 450-480° C. by 0.5˜1 h, held for 6˜12 h, and then reduced to room temperature by 2˜4 h; the temperature of the nucleation area is increased to 440˜460° C. by 0.5˜1 h, held for 6˜12 h, and then reduced to room temperature by 2˜4 h.

14. The method of preparing black phosphorus crystals according to claim 1, wherein in the temperature control program in step (1), the temperature-control program of the feedstock area, and the nucleation area is synchronized, and the temperature of the feedstock area is always 10˜40° C. higher than the temperature of the nucleation area.
